(19) United States
(12) Patent Application Publication
(10) Pub. No.: US 2026/0355907 A1
(43) Pub. Date: Nov. 12, 2026

(54) CUTTING ASSEMBLY FOR ROOFING TILE

(71) Applicant: Tesla, Inc., Austin, TX (US)

(72) Inventors: Jacob PASTERNAK, Austin, TX (US); Brencis PUKINSKIS, Austin, TX (US)

(73) Assignee: Tesla, Inc., Austin, TX (US)

(21) Appl. No.: 19/201,652

(22) Filed: May 7, 2025

(51) Int. Cl. B25B 5/06; E04D 15/02

(52) U.S. Cl. CPC B25B 5/061; E04D 15/02

(57) ABSTRACT

A cutting assembly includes a frame, a support surface supported by the frame and configured to support a material, a guide coupled with the frame, and a tray coupled with the guide and configured to support a saw, the tray defining an opening positioned to receive a blade of the saw. The guide is configured to move relative to the support surface between a first position and a second position. In the second position, the guide clamps the material between the guide and the support surface. The tray is configured to move along a length of the guide such that the blade of the saw cuts the material clamped between the guide and the support surface.

### TECHNICAL FIELD

This application relates generally to cutting assemblies.

### BACKGROUND

Installing roofing tile often requires cutting the roofing tile on site to fit edge areas. Cutting the roofing tile may be dangerous for the operator, may be inefficient because of complex geometries of the roofing tile, and may damage the roofing tile being cut.

### SUMMARY

At least one embodiment relates to a cutting assembly. The cutting assembly includes a frame, a support surface supported by the frame and configured to support a material, a guide coupled with the frame, and a tray coupled with the guide and configured to support a saw, the tray defining an opening positioned to receive a blade of the saw. The guide is configured to move relative to the support surface between a first position and a second position. In the second position, the guide clamps the material between the guide and the support surface. The tray is configured to move along a length of the guide such that the blade of the saw cuts the material clamped between the guide and the support surface.

In some embodiments, the cutting assembly includes a linkage assembly movably coupling the guide with the frame and a biasing element configured to bias the guide into the first position or the second position.

In some embodiments, the biasing element is pivotably coupled with the frame at a first end thereof, and the linkage assembly includes a first bracket pivotably coupled with the guide and the frame and a second bracket pivotably coupled with the biasing element at a second end thereof and coupled with the first bracket between the guide and the frame.

In some embodiments, the linkage assembly includes a handle coupled with the first bracket to facilitate moving the guide between the first position and the second position.

In some embodiments, the biasing element is a gas spring.

In some embodiments, the guide includes a first track and a second track laterally spaced apart from each other, and the tray is slidably coupled with the first track and the second track.

In some embodiments, the cutting assembly includes a first linkage assembly and a second linkage assembly movably coupling the first track of the guide with the frame, and a third linkage assembly and a fourth linkage assembly movably coupling the second track of the guide with the frame.

In some embodiments, the cutting assembly includes a cross-member coupling the first track with the second track such that movement of one of the first track or the second track causes corresponding movement of the other one of the first track or the second track.

In some embodiments, the cutting assembly includes a pad positioned along a bottom surface of the guide to engage with the material when the guide is in the second position.

In some embodiments, the pad provides an indication of a path that the blade of the saw follows as the tray moves along the length of the guide.

In some embodiments, the tray includes at least one clamp configured to secure the saw to the tray.

In some embodiments, the tray includes a bearing coupled with the guide to facilitate translational movement of the tray along the guide.

In some embodiments, the support surface defines a first slot extending in a longitudinal direction and a second slot extending in the longitudinal direction and laterally spaced from the first slot, the cutting assembly further includes a first pin configured to be received within the first slot, and a second pin configured to be received within the second slot. In such embodiments, the first pin and the second pin are configured to engage with the material to orient the material at an angle relative to the guide, and the first pin is selectively repositionable along the first slot and the second pin is selectively repositionable along the second slot to adjust the angle at which the material is oriented.

In some embodiments, the support surface defines an opening positioned to receive the blade of the saw.

At least one embodiment relates to a cutting assembly. The cutting assembly includes a frame, a support surface supported by the frame and configured to support a material, a guide coupled with the frame, and a tray. The guide includes a first track extending in a longitudinal direction, a second track extending in the longitudinal direction, the second track laterally spaced from the first track, and a cross-member extending in a lateral direction between the first track and the second track. The tray is slidably coupled with the first track and the second track, includes a clamp configured to secure a saw to the tray, and defines an opening positioned to receive a blade of the saw. The guide is configured to move relative to the support surface between a first position and a second position. In the second position, the guide clamps the material between the guide and the support surface. The tray is configured to translate along a length of the guide such that the blade of the saw cuts the material clamped between the guide and the support surface.

In some embodiments, the cutting assembly includes a first pad positioned along a bottom surface of the first track and a second pad positioned along a bottom surface of the second track. In such embodiments, the first pad and the second pad engage with the material when the guide is in the second position.

In some embodiments, the first pad or the second pad provides an indication of a path that the blade of the saw follows as the tray translates along the length of the guide.

At least one embodiment relates to a cutting assembly. The cutting assembly includes a frame, a support surface supported by the frame and configured to support a material, a guide coupled with the frame, a tray coupled with the guide and configured to support a saw, the tray defining an opening positioned to receive a blade of the saw, and a first linkage assembly, a second linkage assembly, a third linkage assembly, and a fourth linkage assembly each movably coupling the guide with the frame such that the guide is repositionable between a first position and a second position. The first linkage assembly and the second linkage assembly each include a gas spring pivotably coupled with the frame at a first end thereof, a first bracket pivotably coupled with the guide and the frame, and a second bracket pivotably coupled with the gas spring at a second end thereof and coupled with the first bracket between the guide and the frame. The third linkage assembly and the fourth linkage assembly each include a third bracket pivotably coupled with the guide and the frame. In the second position, the guide clamps the material between the guide and the support surface. The tray is configured to move along a length of the guide such that the blade of the saw cuts the material clamped between the guide and the support surface.

In some embodiments, the cutting assembly includes a handle coupled with the first bracket of the first linkage assembly or the second linkage assembly to facilitate moving the guide between the first position and the second position.

In some embodiments, the guide includes a first track extending in a longitudinal direction along the length of the guide and a second track extending in the longitudinal direction along the length of the guide, the second track laterally spaced from the first track. In such embodiments, the first linkage assembly and the second linkage assembly are coupled to the first track and the second track, respectively, proximate a first longitudinal end of the guide. In such embodiments, the third linkage assembly and the fourth linkage assembly are coupled to the first track and the second track, respectively, proximate a second longitudinal end of the guide.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a cutting assembly, according to an embodiment.

FIG. 2 is a perspective view of the cutting assembly of FIG. 1, according to an embodiment.

FIG. 3 is a left side perspective view of the cutting assembly of FIG. 1, according to an embodiment.

FIG. 4 is a front view of the cutting assembly of FIG. 1, according to an embodiment.

FIG. 5 is a top view of the cutting assembly of FIG. 1, according to an embodiment.

FIG. 6 is a bottom view of the cutting assembly of FIG. 1, according to an embodiment.

FIG. 7 is a perspective view of a tray of the cutting assembly of FIG. 1, according to an embodiment.

FIG. 8 is a detailed, exploded, perspective view of the tray of FIG. 7, according to an embodiment.

FIG. 9 is a detailed, exploded, perspective view of a pin of the cutting assembly of FIG. 1, according to an embodiment.

FIG. 10 is an exploded perspective view of a guide of the cutting assembly of FIG. 1, according to an embodiment.

FIG. 11 is a right side perspective view of the cutting assembly of FIG. 1, according to an embodiment.

FIG. 12 is a detailed, exploded, perspective view of a linkage assembly of the cutting assembly of FIG. 1, according to an embodiment.

FIG. 13 is an exploded perspective view of a linkage assembly of the cutting assembly of FIG. 1, according to an embodiment.

FIG. 14 is a detailed bottom view of the linkage assembly of FIG. 12, according to an embodiment.

FIG. 15 is a detailed section view of the linkage assembly of FIG. 12, according to an embodiment.

FIG. 16 is a perspective view of a saw supported by the cutting assembly of FIG. 1 in a first position, according to an embodiment.

FIG. 17 is a perspective view of the saw of FIG. 16 secured to the tray of FIG. 7, according to an embodiment.

FIG. 18 is a perspective view of a material supported and clamped by the cutting assembly of FIG. 1 in a second position, according to an embodiment.

FIG. 19 is a perspective view of the saw of FIG. 16 secured to the tray of FIG. 7, according to an embodiment.

FIG. 20 is a perspective view of the saw of FIG. 16 secured to the tray of FIG. 7, according to an embodiment.

FIG. 21 is a perspective view of the material of FIG. 18 supported and clamped by the cutting assembly of FIG. 1 in the second position, according to an embodiment.

FIG. 22 is a perspective view of the material of FIG. 18, according to an embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a cutting assembly facilitates clamping a material such as roofing tiles, sheet metal, and glass panels, coupling to a saw (e.g., a circular saw, a jigsaw, etc.), and guiding the saw to cut the clamped material. The cutting assembly includes a frame supporting a platform above the ground surface, a tray configured to support and secure the saw thereto, and a guide coupled to the frame by a linkage assembly and movable relative to the platform to selectively clamp the material. The guide can transition between a first, raised position, allowing material to be placed on and supported by the platform, and a second, clamped position, clamping the material between the guide and the platform. The linkage assembly includes gas springs and brackets that facilitates movably coupling the guide with the frame and selectively retaining the guide in the first position or the second position. The platform defines a first slot extending in a longitudinal direction and a second slot extending in the longitudinal direction and laterally spaced from the first slot. A first pin is configured to be received within the first slot, and a second pin is configured to be received within the second slot and engage with the material to orient the material at an angle relative to the guide. The cutting assembly facilitates cutting materials with complex and irregular geometries, such as roofing tiles with overlapping end portions, without causing deformation. The ability to clamp the material securely allows the operator to use both hands to guide the saw, increasing precision. The cutting assembly can accommodate different types of saws from various manufacturers, and is lightweight and easy to transport, making it suitable for use at different job sites.

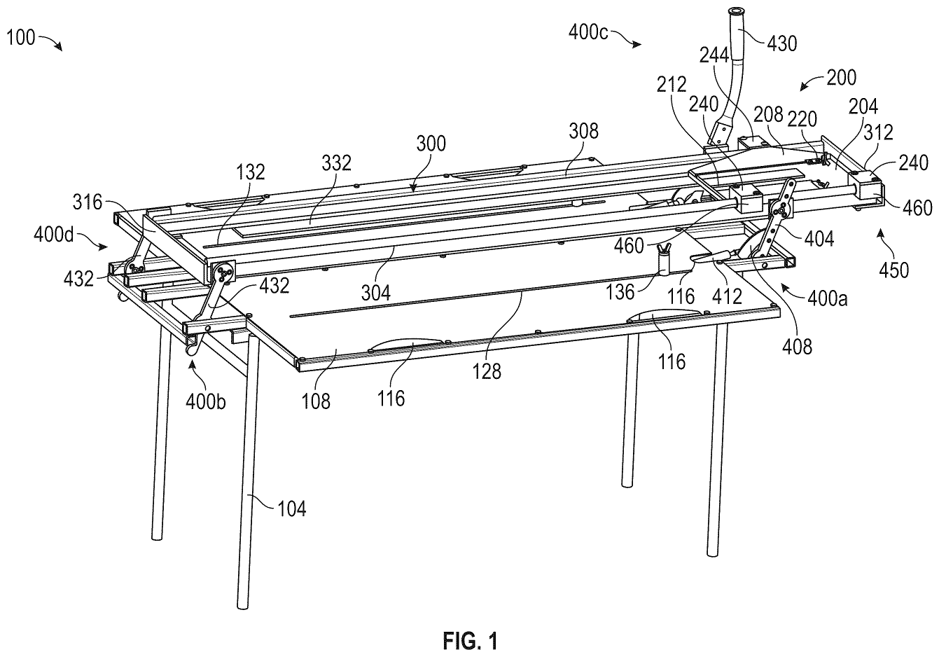

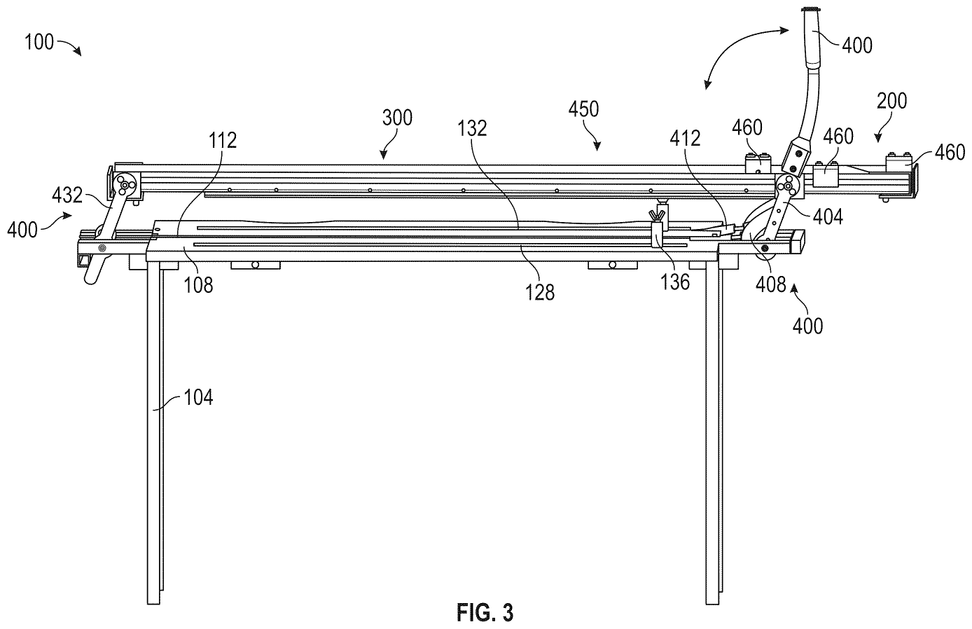

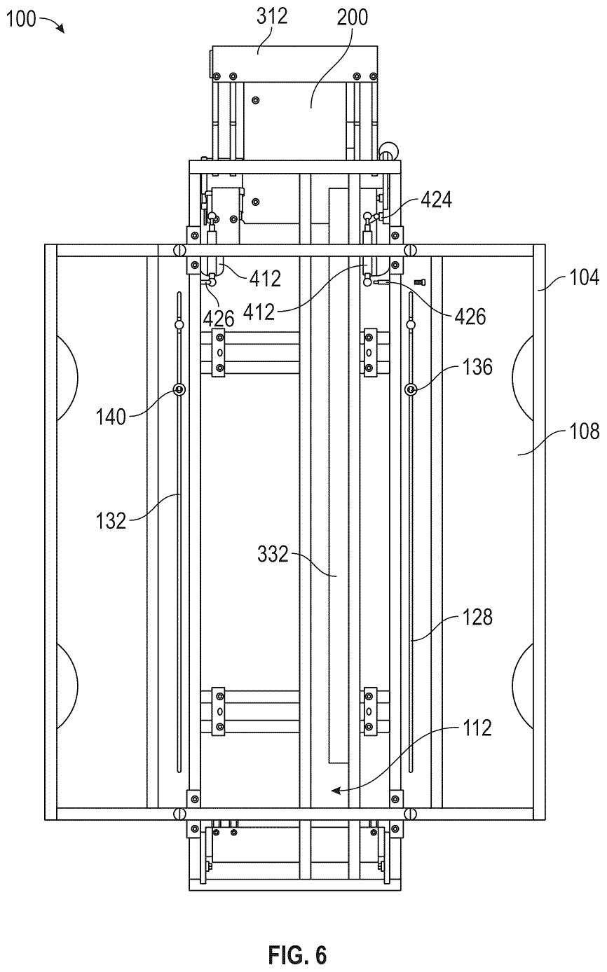

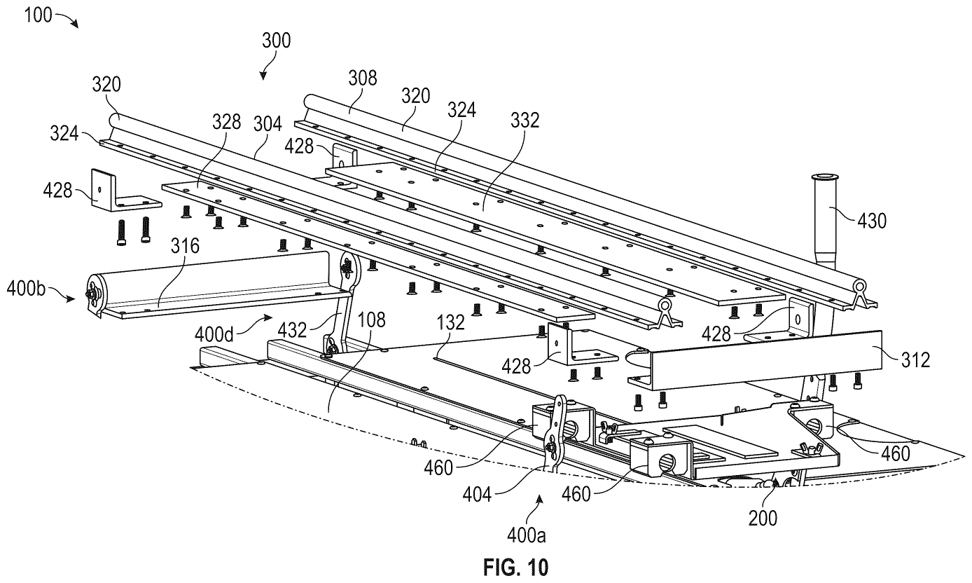

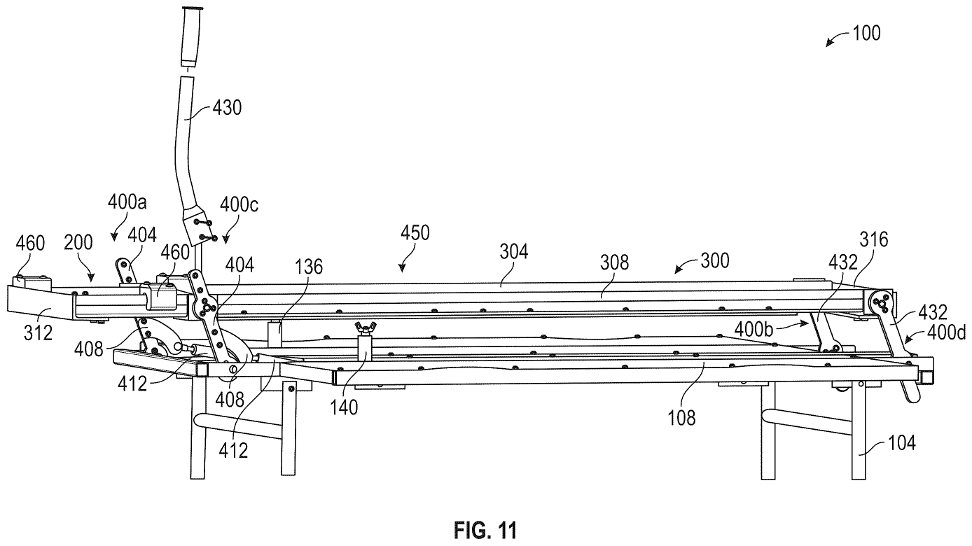

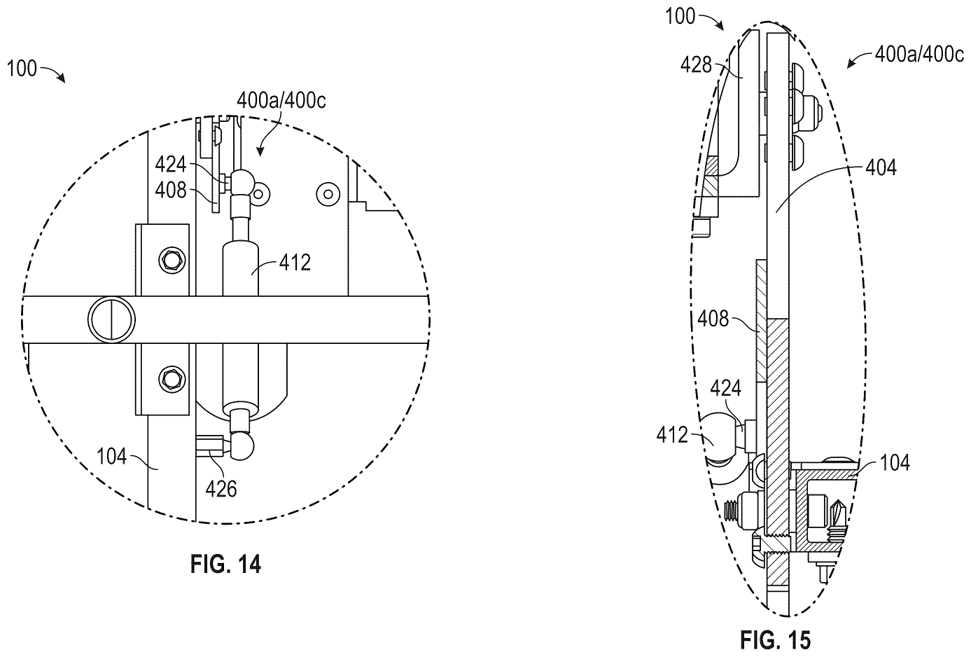

As shown in FIGS. 1-21, a roofing tile cutting assembly (e.g., tile trimmer, metal cutting assembly, glass cutting assembly, clamping assembly, etc.), shown as cutting assembly 100, includes a support frame (e.g., frame assembly), shown as frame 104; a support surface (e.g., support deck), shown as platform 108, supported by the frame 104; a tray assembly (e.g., saw tray, saw guide, saw support, saw clamp, etc.), shown as tray 200; a rail assembly (e.g., tray guide, guide assembly, etc.), shown guide 300, coupled with the frame 104; and a mechanical linkage system (e.g., four-bar linkage), shown as linkage assembly 400, movably coupling the guide 300 with the frame 104. According to an embodiment, the cutting assembly 100 is configured to facilitate clamping a material (e.g., the roofing tile 520, roofing tile, sheet metal, glass panel, wood, polymers, ceramic, etc.), coupling to a saw (e.g., circular saw, jigsaw, etc.), and guiding the saw to cut the clamped material.

As shown in FIGS. 1-9, 11, 12, and 14-21, the frame 104 includes one or more straight or bent sections configured to support the platform 108, the tray 200, the guide 300, and the linkage assembly 400. The frame 104 includes legs (e.g., supports) extending in a substantially vertical direction and configured to engage with a ground surface to space the platform 108, the tray 200, the guide 300, and the linkage assembly 400 from the ground surface. In some embodiments, the frame 104 is fixedly coupled with the ground surface to inhibit movement of the cutting assembly 100 along the ground surface. As shown in FIGS. 1-9, 11, 12, and 14-21, the frame 104 includes one or more cross-members (e.g., supports) extending in a substantially horizontal plane parallel with the ground surface and configured to support the platform 108, the tray 200, the guide 300, and the linkage assembly 400 above the legs. In some embodiments, the frame 104 includes one or more braces (e.g., supports) coupled and extending between the legs to provide additional rigidity and stabilization to the legs and the cutting assembly 100.

As shown in FIGS. 1-12 and 16-21, the platform 108 defines a support surface configured to engage with a bottom surface of the material and support the material being clamped and cut using the cutting assembly 100. The platform 108 may extend within a substantially horizontal plane parallel with the ground surface. As shown in FIGS. 1-12 and 16-21, the platform 108 is coupled to and supported by the frame 104. In some embodiments, the platform 108 is removably coupled to the frame 104 (e.g., using one or more fasteners such as nuts, bolts, screws, nails, clamps, rivets, etc.) to facilitate replacing the platform 108 with a new platform 108 (e.g., after damage, scrapes, abrasions, cracks, etc., to the old platform 108). In other embodiments, the platform 108 is integrally formed (e.g., welded) with the frame 104 as a single, unitary body.

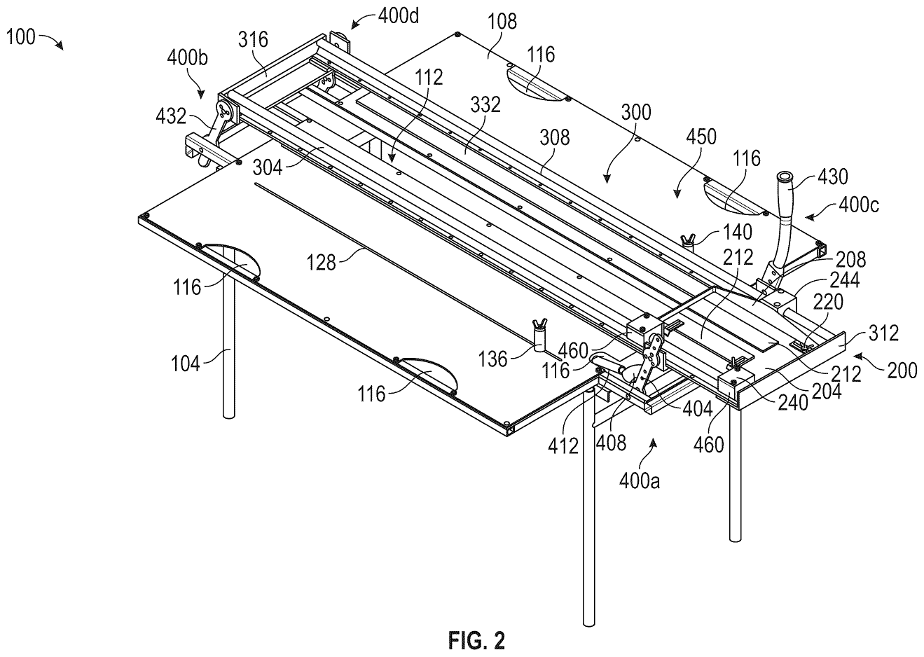

As shown in FIGS. 2, 3, 5-7, and 21, the platform 108 defines an first opening (e.g., gap, space, slot, etc.), shown as platform aperture 112, extending through the platform 108 in a longitudinal direction (e.g., a direction in which the saw travels to cut the material). The platform aperture 112 provides a space for a saw blade of the saw to extend through the platform 108 to cut the material without cutting the platform 108. In some embodiments, the platform 108 is formed as a single, unitary body defining the platform aperture 112. In other embodiments, the platform 108 includes two members (e.g., two pieces, platforms, bodies, etc.) laterally spaced apart from each other and coupled to the frame 104 such that the space between the two members defines the platform aperture 112. In such embodiments, one or more of the two members of the platform 108 may be repositionable relative to the frame 104 to vary a lateral dimension (e.g., width) of the platform aperture 112. Further, in such embodiments, the platform aperture 112 may extend from a first longitudinal end to a second longitudinal end of the platform 108 opposite the first longitudinal end. In some embodiments, the platform aperture 112 is dimensioned in a lateral direction (or the platform 108 is positioned relative to the frame 104 to position the platform aperture 112) according to a lateral position of the saw (and the saw blade thereof) coupled with the tray 200. By way of example, the platform aperture 112 may be sufficiently wide enough to accommodate for the saw being coupled to the tray 200 at various lateral positions (e.g., such that the saw does not cut the platform 108). In some embodiments, the platform aperture 112 is dimensioned in the longitudinal direction (or the platform 108 is positioned relative to the frame 104 to position the platform aperture 112) according to a longitudinal length of the guide 300 and, accordingly, a longitudinal length of a cutting path of the saw (e.g., a path that the blade of the saw follows as the tray 200 moves along the length of the guide 300). By way of example, the platform aperture 112 may be sufficiently long enough to accommodate for the longitudinal length of the cutting path of the saw (e.g., such that the saw does not cut the platform 108).

As shown in FIGS. 1, 2, 5, 6, 9, and 10, the platform 108 includes a plurality of cutouts (e.g., notches, recesses, etc.), shown as cutouts 116, along an outer perimeter of the platform 108. One or more of the cutouts 116 are positioned along the platform 108 at a longitudinal end of the cutting assembly 100 and are configured (e.g., sized, positioned, etc.) to receive at least a portion of the linkage assembly 400 to permit movement of the linkage assembly 400 relative to the platform 108 without unintentionally contacting one or more components of the linkage assembly 400. By way of example, and as discussed in greater detail below, the cutouts 116 may receive at least a portion of a biasing element (e.g., the gas spring 412) of the linkage assembly 400 as the guide 300 is moved relative to the platform 108. In some embodiments, the platform 108 does not include the cutouts 116.

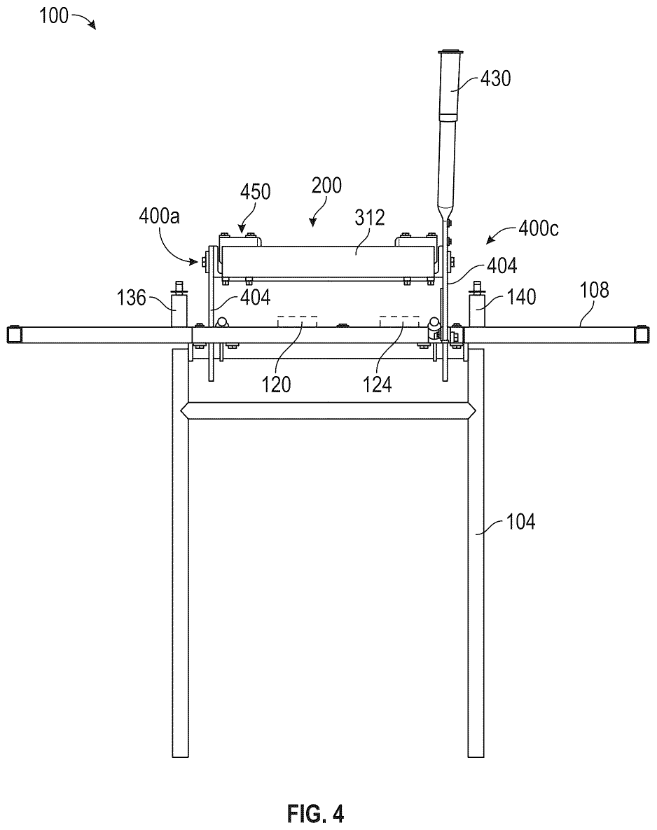

As shown in FIG. 4, the cutting assembly 100 includes a plurality of material supports, shown as first material support 120 and second material support 124, positioned along a top surface of and supported by the platform 108. The first material support 120 and the second material support 124 are configured to engage with a bottom surface of the material being clamped and cut using the cutting assembly 100. In some embodiments, the first material support 120 and the second material support 124 facilitate leveling and stabilizing the material on the platform 108. By way of example, the material may have an irregular geometry (e.g., such that a portion of the bottom surface is vertically spaced from the platform 108) such that clamping the material without the first material support 120 or the second material support 124 may deform the material. In such an example, the first material support 120 and the second material support 124 may provide consistent support for the material to avoid or limit deformation thereof while being clamped or cut. In some embodiments, the first material support 120 and the second material support 124 engage with the material to limit vibration propagation throughout (e.g., dampen vibrations experienced by) the cutting assembly 100 and the material during cutting operations. In some embodiments, the first material support 120 and the second material support 124 provide a friction force between the material to avoid or limit slippage or other unintentional movement of the material during cutting operations. The first material support 120 and the second material support 124 may be manufactured from or include a material such as rubber, foam, silicone, or another suitable material configured to engage with the material being clamped and cut without damaging the material. In some embodiments, the first material support 120 and the second material support 124 are interchangeable (e.g., to change a material thereof) based on the material being clamped and cut. In some embodiments, the cutting assembly 100 does not include the first material support 120 and the second material support 124. In such embodiments, the platform 108 may engage directly with the material, and may be manufactured from or include a material such as rubber, foam, silicone, or another suitable material configured to engage with the material supported thereby without damaging the material.

As shown in FIGS. 1-3, 5, 6, 8, 9, 10, 12, and 21, the platform 108 defines a second opening (e.g., gap, space, slot, etc.), shown as first slot 128, extending through the platform 108 in the longitudinal direction, and a third opening (e.g., gap, space, slot, etc.), shown as second slot 132, extending through the platform 108 in the longitudinal direction. The first slot 128 and the second slot 132 are laterally spaced apart from each other, and the platform aperture 112 is positioned laterally between the first slot 128 and the second slot 132.

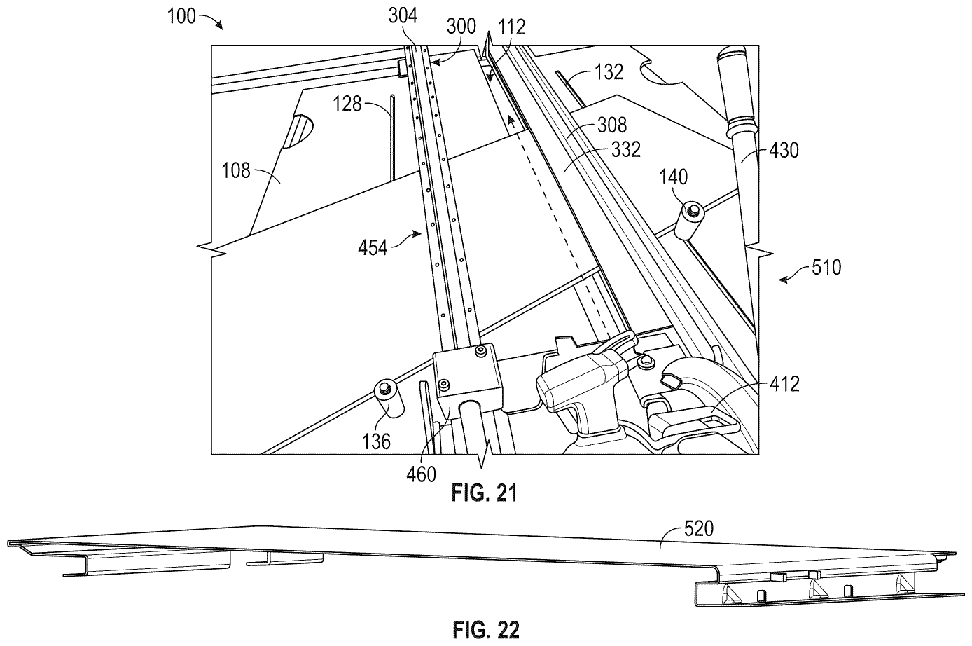

As shown in FIGS. 1-6, 9, 11, and 21, the cutting assembly 100 includes a material alignment assembly, including a first pin (e.g., material engagement feature, material alignment feature, etc.), shown as first pin 136, and a second pin (e.g., material engagement feature, material alignment feature, etc.), shown as second pin 140. The first pin 136 is configured to be received within the first slot 128 and the second pin 140 is configured to be received within the second slot 132. The first pin 136 and the second pin 140 are configured to engage with the material supported by the platform 108 to orient the material at an angle relative to the guide 300 (e.g., relative to the cutting path of the saw). The first pin 136 and the second pin 140 are selectively repositionable within and along the length of the first slot 128 and the second slot 132, respectively. Repositioning the first pin 136 and the second pin 140 facilitates adjusting the angle at which the material is oriented. By way of example, as shown in FIG. 21, the first pin 136 may be positioned at a first position along the length of the first slot 128 and the second pin 140 may be positioned at a second position along the length of the second slot 132 that is longitudinally offset from the first position such that when the material is engaged with the first pin 136 and the second pin 140, the material is oriented at the angle (e.g., the angle established based on the positions of the first pin 136 and the second pin 140). The first pin 136 and the second pin 140 facilitate making repeated cuts (e.g., cutting different pieces of material) at the same angle without needing to measure, mark, etc., or otherwise determine the angle before making each subsequent cut. Accordingly, the first pin 136 and the second pin 140 reduce the time it takes to cut multiple pieces of material (e.g., because the angle only needs to be set once), reduce the number of human errors caused by incorrect measurements, and therefore reduce material waste.

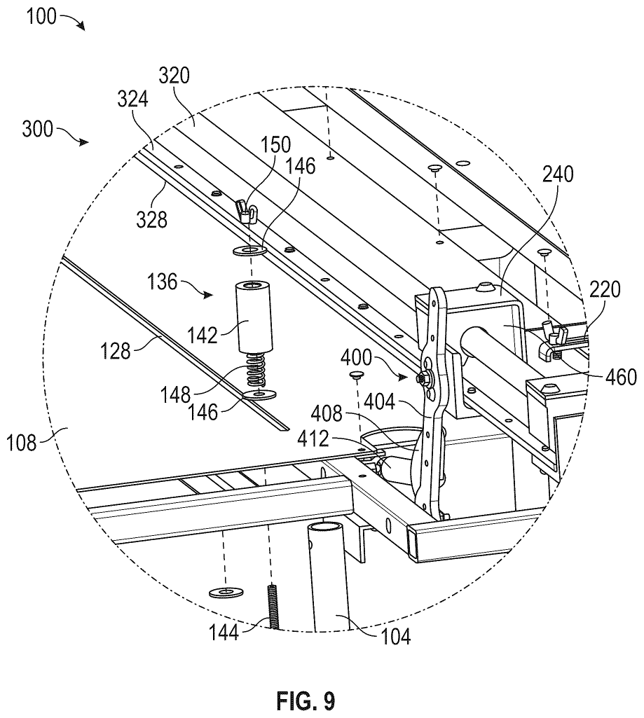

As shown in FIG. 9, the first pin 136 includes a body 142, a fastener 144 (e.g., a bolt), washers 146, a biasing element 148 (e.g., a spring), and a nut 150 collectively configured to facilitate repositioning the first pin 136 within and along the length of the first slot 128. The fastener 144 may be configured to extend (e.g., vertically) through the first slot 128 and the body 142. The biasing element 148 may be received within the body 142 such that the biasing element 148 is disposed around (e.g., receives) the fastener 144 when the fastener 144 extends through the body 142. The fastener 144 may extend through a top surface of the body 142 such that the nut 150 may engage (e.g., via threads of the fastener 144 and the nut 150) with the fastener 144. A first washer 146 may be disposed between the body 142 and the platform 108, and a second washer 146 may be disposed between the nut 150 and the body 142. According to an embodiment, the engagement between the fastener 144 and the nut 150 induces a force on the body 142 and the platform 108 to retain the first pin 136 at a respective location along the first slot 128. The nut 150 may be turned to reduce the force on the body 142 and the platform 108 (e.g., to loosen the engagement between the body 142 and the platform 108) such that the first pin 136 can be repositioned (e.g., moved) within and along the first slot 128. Similarly, the nut 150 may be turned to increase the force on the body 142 and the platform 108 (e.g., to tighten the engagement between the body 142 and the platform 108) such that the first pin 136 is retained at a respective position within and along the first slot 128. According to an embodiment, the second pin 140 includes the body 142, the fastener 144, the washers 146, the biasing element 148, and the nut 150 to facilitate repositioning the second pin 140 within and along the second slot 132. In some embodiments, the first pin 136 and the second pin 140 are otherwise selectively repositionable within and along the first slot 128 and the second slot 132, respectively.

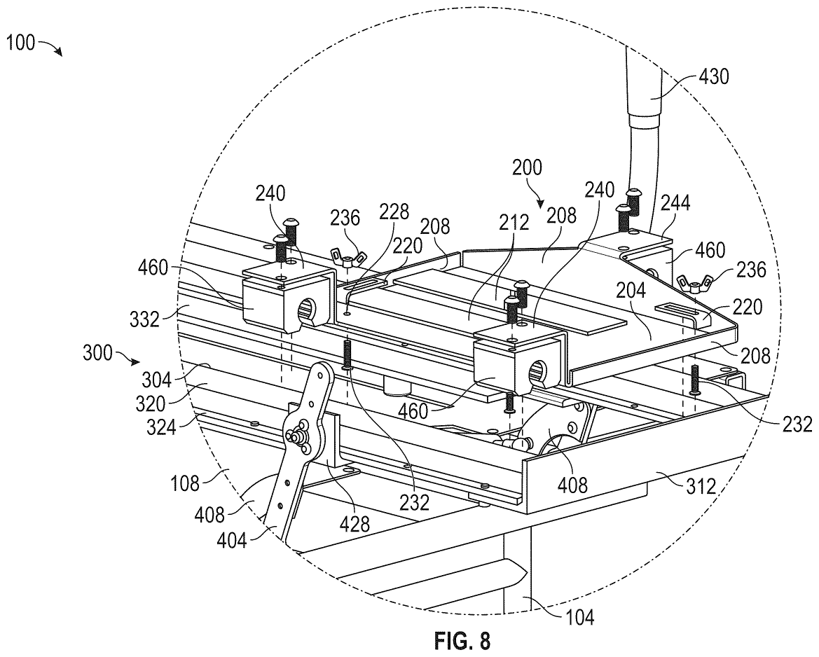

As shown in FIGS. 1-8, 11, and 16-21, the tray 200 includes a platform (e.g., support surface), shown as base 204, and walls, shown as sidewalls 208, extending vertically upwards from the base 204. The base 204 is configured to support the saw thereon. The sidewalls 208 extend from the base 204 at the edges thereof. As shown in FIG. 8, the tray 200 includes a first sidewall 208 along a first, leading, longitudinal edge of the base 204 and a second sidewall 208 along a second, lateral edge of the base 204. In some embodiments, the first sidewall 208 and the second sidewall 208 engage with the saw to prevent the saw from unintentionally sliding off of the base 204. In some embodiments, the first sidewall 208 and the second sidewall 208 engage with the saw to align the saw at a proper position on the base 204 (e.g., such that the saw blade is in the correct position to properly cut the material). In some embodiments, the tray 200 does not include the sidewalls 208.

As shown in FIGS. 2, 5, 7, and 8, the tray 200 includes a plurality of material supports, shown as pads 212, positioned along a top surface of the base 204. The pads 212 are configured to engage with a bottom surface of the saw supported by the tray 200. In some embodiments, the pads 212 engage with the saw to limit vibration propagation throughout (e.g., dampen vibrations experienced by) the cutting assembly 100, the saw, and the material during cutting operations. In some embodiments, the pads 212 provide a friction force with the saw to avoid or limit slippage or other unintentional movement of the saw during cutting operations. The pads 212 may be manufactured from or include a material such as rubber, foam, silicone, or another suitable material configured to engage with the saw without damaging the saw. In some embodiments, the pads 212 are interchangeable (e.g., to change a material thereof). In some embodiments, the pads 212 are coupled (e.g., adhered) to the base 204. In other embodiments, the pads 212 are received within apertures in the base 204. In some embodiments, the cutting assembly 100 does not include the pads 212. In such embodiments, the base 204 may engage directly with the saw.

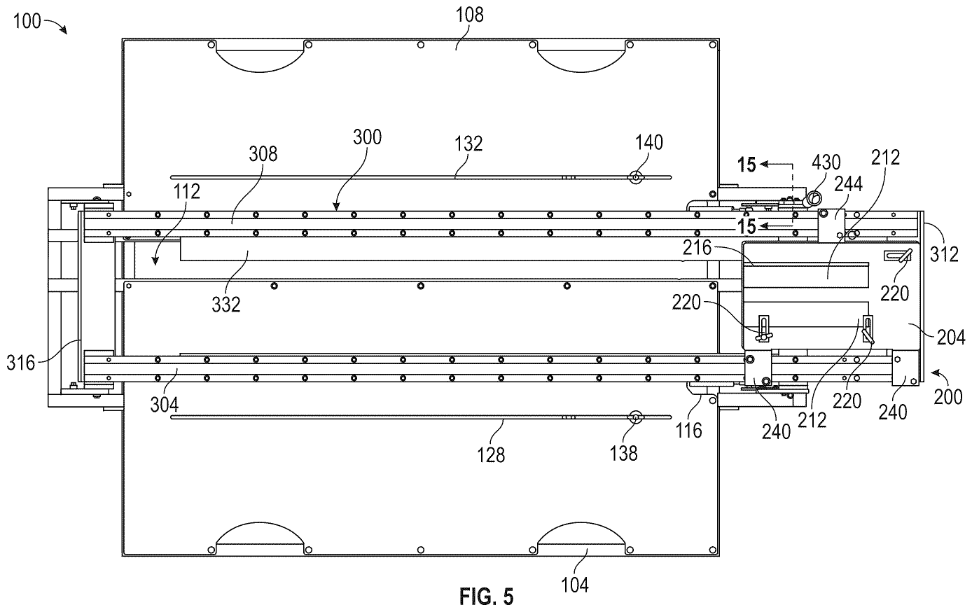

As shown in FIGS. 5, 7, and 16, the tray 200 defines an opening (e.g., aperture, cutout, etc.), shown as blade slot 216, configured to receive a saw blade of the saw. The saw blade may extend through the blade slot 216 to cut the material during cutting operations as the tray 200 passes over the material. In some embodiments, the blade slot 216 extends through the pads 212. As shown in FIGS. 5, 7, and 16, the blade slot 216 is positioned proximate the second sidewall 208 at a first lateral side of the tray 200. In some embodiments, the blade slot 216 is positioned at a second lateral side opposite the first lateral side of the tray 200. In other embodiments, the tray 200 defines multiple blade slots 216 configured to receive the saw blade at various positions along the tray 200 (e.g., based on the configuration of the saw).

As shown in FIGS. 1, 2, 5, 7-10, and 17, the tray 200 includes a plurality of clamps (e.g., saw engagement features), shown as saw clamps 220, configured to engage with the saw to secure the saw to the tray 200 and inhibit movement of the saw along the tray 200 during cutting operations. Specifically, the saw clamps 220 are configured to engage with the saw to clamp a base plate (e.g., shoe, plate, etc.) of the saw between the base 204 and the saw clamps 220. The tray 200 includes three saw clamps 220 variously positioned about the base 204 to engage with the saw at various locations. In some embodiments, the tray 200 includes more or fewer than three saw clamps 220. As shown in FIGS. 5, 7, 8, and 17, a first end of the saw clamps 220 is coupled (e.g., fixed, welded, etc.) to the base 204 and a second end of the caw clamps 220 is free from the base 204 (e.g., vertically spaced from the base 204). The saw clamps 220 define openings, shown as saw clamp slots 224, and the base 204 defines openings, shown as tray openings 228, configured to cooperatively receive fasteners 232 (e.g., bolts). The fasteners 232 may extend (e.g., vertically) through the clamp slots 224 and the tray openings 228, and nuts 236 may engage (e.g., via threads of the fasteners 232 and the nuts 236) with the fasteners 232 along top surfaces of the saw clamps 220. According to an embodiment, the engagement between the fasteners 232 and the nuts 236 induces a force on the tray 200 (e.g., the base 204) and the saw clamps 220 to clamp the saw between the saw clamps 220 and the base 204. The nuts 236 may be turned to reduce the force on the tray 200 and the saw clamps 220 (e.g., to loosen the clamping force on the saw) such that a space between the second ends of the saw clamps 220 and the base 204 increases and the saw can be removed from the tray 200. Similarly, the nuts 236 may be turned to increase the force on the tray 200 and the saw clamps 220 (e.g., to increase the clamping force on the saw) such that the space between the second ends of the saw clamps 220 and the base 204 decreases and the saw is secured to the tray 200 by the saw clamps 220. In some embodiments, the saw is otherwise suitable secured to the tray 200. In other embodiments, the saw is integrally formed with the tray 200.

As shown in FIGS. 1-3, 5, 7, 8, 10, 16, and 18-21, the tray 200 includes a pair of first flanges, shown as first brackets 240, and a second flange, shown as second bracket 244. The first brackets 240 extend vertically upwards and laterally away from the tray 200. In other words, the first brackets 240 include first portions coupled to and extending vertically upwards and away from the tray 200 and second portions coupled to the first portions and extending laterally away from the first portions and the tray 200. The first brackets 240 are positioned along a fourth, lateral edge of the tray 200 opposite the second, lateral edge of the tray 200 (e.g., where the second sidewall 208 is located). A first bracket of the first brackets 240 is positioned proximate the first, leading, longitudinal edge of the tray 200, and a second bracket of the first brackets 240 is longitudinally spaced from the first bracket proximate a third, trailing, longitudinal edge of the tray 200. The second bracket 244 is positioned along the second, lateral edge of the tray 200 and extends laterally away from the tray 200. Specifically, the second bracket 244 is coupled to the second sidewall 208 and extends laterally away from the second sidewall 208. The second portions of the first brackets 240 and the second bracket 244 may be positioned at substantially the same vertical height relative to the tray 200 and the guide 300 such that the tray 200 is substantially level (e.g., when the tray 200 is coupled with the guide 300). In some embodiments, the tray 200 includes more or fewer than two first brackets 240 and/or more than one second bracket 244. As shown in FIGS. 1, 2, 3, 5, 7, 8, 10, 16, and 18-21, the first brackets 240 and the second bracket 244 define apertures configured to receive fasteners to facilitate coupling the tray 200 to one or more other components of the cutting assembly 100 (e.g., the bearings 460).

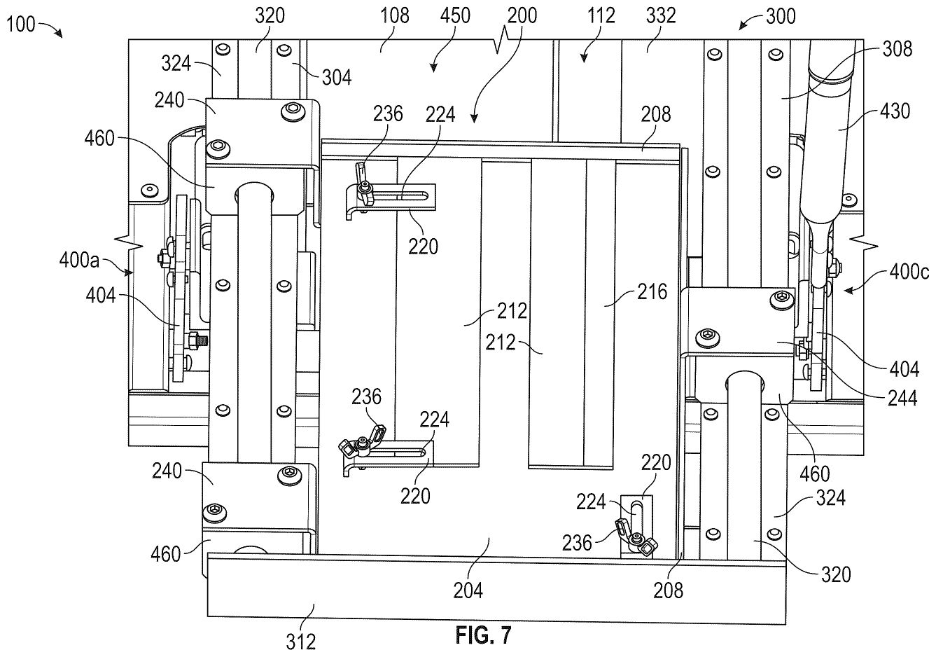

As shown in FIGS. 1-5, 7-11, and 16-21, the guide 300 includes a first rail (e.g., member, guide, shaft, etc.), shown as first track 304; a second rail (e.g., member, guide, shaft, etc.), shown as second track 308, laterally spaced apart from the first track 304; a first member, shown as first cross-member 312, coupling the first track 304 with the second track 308; and a second member, shown as second cross-member 316, coupling the first track 304 with the second track 308. The first track 304 and the second track 308 extend in the longitudinal direction and define a longitudinal length of the cutting path of the saw. As shown in FIGS. 7-10, the first track 304 and the second track 308 each include a first portion (e.g., shaft portion), shown as bearing engagement portion 320, and a second portion, shown as pad flange 324, extending from a bottom surface of the bearing engagement portion 320. The bearing engagement portion 320 defines a generally arcuate shape to facilitate translation of a bearing (e.g., the bearings 460) therealong. In some embodiments, the bearing engagement portion 320 is otherwise shaped to permit translation of the bearing. The pad flange 324 extends below and in opposing lateral directions from the bearing engagement portion 320. The bearing engagement portion 320 includes a plurality of apertures along the length thereof to facilitate coupling one or more components (e.g., the first pad 328, the second pad 332, the guide bracket 428, etc.) to the first track 304 and the second track 308. The bearing engagement portion 320 and the pad flange 324 may be integrally formed with each other to form the first track 304 and the second track 308.

As shown in FIGS. 1-8, 10, and 11, the first cross-member 312 is coupled to the first track 304 and the second track 308 at first, longitudinal ends thereof, and the second cross-member 316 is coupled to the first track 304 and the second track 308 at second, longitudinal ends thereof opposite the first, longitudinal ends. As discussed in greater detail below, the first cross-member 312 and the second cross-member 316 couple the first track 304 with the second track 308 such that movement (e.g., vertical movement, longitudinal movement, and/or lateral movement) of one of the first track 304 or the second track 308 causes corresponding movement of the other one of the first track 304 or the second track 308.

As shown in FIGS. 1, 2, 5, 7, 10, 16, and 18-21, the guide 300 includes a first cushion, shown as first pad 328, and a second cushion (e.g., saw path indicator, guide, zero clearance insert, etc.), shown as second pad 332. The first pad first pad 328 is configured to couple to the first track 304 along the bottom surface thereof, and the second pad 332 is configured to couple to the second track 308 along the bottom surface thereof. The first pad 328 and the second pad 332 may include apertures along the length thereof configured to receive fasteners. The fasteners may extend through the apertures of the first pad 328 and the second pad 332 and the apertures of the pad flange 324 of the first track 304 and the second track 308 to couple the first pad 328 to the first track 304 and the second pad 332 to the second track 308. The first pad 328 and the second pad 332 are positioned between the first track 304 and the material and between the second track 308 and the material, respectively, and are configured to engage with the material being clamped and cut using the cutting assembly 100 to avoid or limit damage to the material (e.g., caused by contact between (i) the first track 304 and the second track 308 and (ii) the material). In some embodiments, the first pad 328 and the second pad 332 engage with the material to limit vibration propagation throughout (e.g., dampen vibrations experienced by) the cutting assembly 100 and the material during cutting operations. In some embodiments, the first pad 328 and the second pad 332 provide a friction force between the material to avoid or limit slippage or other unintentional movement of the material during cutting operations. The first pad 328 and the second pad 332 may be manufactured from or include a material such as rubber, foam, silicone, or another suitable material configured to engage with the material being clamped and cut without damaging the material.

As shown in FIGS. 1, 2, 5, 7, 16, and 18-21, when the second pad 332 is coupled with the second track 308, the second pad 332 extends laterally inward relative to the second track 308. In other words, the second pad 332 extends beyond an edge of the second track 308 in a direction towards a lateral centerline of the guide 300. The second pad 332 provides an indication of the path that the blade of the saw follows as the tray 200 moves along the length of the guide 300 (as discussed in greater detail below). In some embodiments, the second pad 332 providing the indication of the path of the blade is used in coordination with the first pin 136 and the second pin 140. In other embodiments, the second pad 332 provides the indication of the path of the blade such that the material can be marked (e.g., with a pencil, chalk, marker, etc. ; by scoring the material; etc.) along a desired cut path, the mark can be aligned with the second pad 332, and the material can be cut (e.g., without aligning/angling the material using the first pin 136 and the second pin 140) along the mark. In some embodiments, the tray openings 228 extends laterally inward relative to the first track 304 and provides an indication of the path that the blade of the saw follows as the tray 200 moves along the length of the guide 300.

As shown in FIGS. 1-15 and 18-20, the linkage assembly 400 includes a first linkage assembly 400a and a second linkage assembly 400b configured to movably couple the first track 304 of the guide 300 with the frame 104, and a third linkage assembly 400c and a fourth linkage assembly 400d configured to movably couple the second track 308 of the guide 300 with the frame 104. The first linkage assembly 400a and the third linkage assembly 400c are coupled to the guide 300 at a first, longitudinal end thereof and are laterally spaced apart by the guide 300. Similarly, the second linkage assembly 400b and the fourth linkage assembly 400d are coupled to the guide 300 at a second, longitudinal end thereof and are laterally spaced apart by the guide 300.

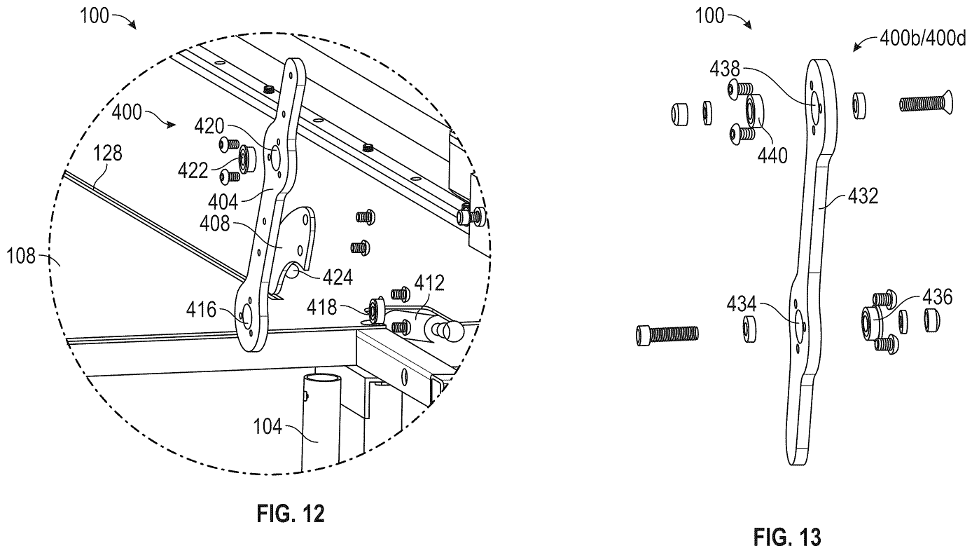

As shown in FIGS. 1-4, 6, 8, 9, and 11-15, the first linkage assembly 400a and the third linkage assembly 400c each include a first member, shown as first bracket 404, a second member, shown as second bracket 408, and a biasing member (e.g., spring, coil spring, linear actuator, etc.), shown as gas spring 412. The first bracket 404 defines a first opening, shown as first aperture 416, configured to receive a rolling element, shown as first bearing 418, and a second opening, shown as second aperture 420, configured to receive a rolling element, shown as second bearing 422. As shown in FIG. 12, the first aperture 416 is positioned along the length of the first bracket 404 at a first end thereof, and the second aperture 420 is positioned along the length of the first bracket 404 between the first end and a second end thereof. In some embodiments, the second aperture 420 is positioned at the second end of the first bracket 404. As shown in FIGS. 1-3, 8, 11, 12, 14, and 15, the second bracket 408 defines an arcuate shape (e.g., a half-semicircular shape, a quarter-circular shape, etc.) and includes a joint, shown as ball joint 424. The ball joint 424 extends laterally in a direction towards the gas spring 412.

As shown in FIGS. 1-3, 6, 11, 12, 14, and 15, the gas spring 412 is pivotably coupled to the frame 104 via a joint, shown as ball joint 426, at a first end thereof (e.g., at a housing defining a chamber of the gas spring 412), and is pivotably coupled to the second bracket 408 via the ball joint 424 at a second end thereof (e.g., at an end of a piston rod of the gas spring 412). The ball joint 426 extends laterally from the frame 104 in a direction towards the gas spring 412. Generally, the gas spring 412 uses compressed gas to provide a linear force. By way of example, when a force is applied to the gas spring 412 (e.g., to the piston rod from the second bracket 408), a piston compresses and pressurizes gas in a chamber of the gas spring 412. The compressed gas then applies an opposing force on the piston, and therefore applies the linear force on the second bracket 408. The piston rod may extend and the gas pressure may decrease to facilitate controlled extension of the gas spring 412. In other words, a pressure differential within the chamber of the gas spring 412 biases the piston rod to an extended position and resists retraction of the piston rod (e.g., resists compression of the gas within the chamber).

As shown in FIGS. 1-3, 11, 12, 14, and 15, the second bracket 408 is pivotably coupled to the gas spring 412 at a first end thereof via a coupling between the ball joint 424 and a socket (e.g., coupler) of the gas spring 412. The second bracket 408 is coupled to the first bracket 404 at a second end thereof between the first aperture 416 and the second aperture 420 such that the first bracket 404 and the second bracket 408 do not move relative to each other. In other words, the second bracket 408 is fixedly coupled to the first bracket 404 (e.g., using one or more fasteners) between (e.g., vertically) the guide 300 and the frame 104. The first bracket 404 is pivotably coupled to the frame 104 at or proximate a first end thereof via the first bearing 418 and pivotably coupled to the guide 300 at or proximate a second end thereof via the second bearing 422. More specifically, the first bracket 404 is pivotably coupled with a bracket, shown as guide bracket 428, coupled to the pad flange 324 of the first track 304 and the second track 308.

As shown in FIGS. 1-5, 7, 8, 10, 11, 16, and 18-21, the linkage assembly 400 includes a grip (e.g., shaft, manipulator, knob, etc.), shown as handle 430, coupled with the first bracket 404 of the third linkage assembly 400c. As discussed in greater detail below, the handle 430 facilitates movement of the guide 300 between positions (e.g., between the first position 450 and the second position 454). By way of example, moving the handle 430 may cause the first bracket 404 and the guide 300 coupled therewith to move. In some embodiments, the handle 430 is coupled with the first bracket 404 of the first linkage assembly 400a.

As shown in FIGS. 1-3, 10, 11, and 13, the second linkage assembly 400b and the fourth linkage assembly 400d each include a third member, shown as third bracket 432. The third bracket 432 defines a first opening, shown as first aperture 434, configured to receive a rolling element, shown as first bearing 436, and a second opening, shown as second aperture 438, configured to receive a rolling element, shown as second bearing 440. As shown in FIG. 13, the first aperture 434 is positioned along the length of the third bracket 432 at or proximate a first end thereof, and the second aperture 438 is positioned along the length of the third bracket 432 at or proximate a second end thereof opposite the first end. The third bracket 432 is pivotably coupled to the frame 104 at the first end thereof via the first bearing 436 and pivotably coupled to the guide 300 at the second end thereof via the second bearing 440. More specifically, the third bracket 432 is pivotably coupled with the guide bracket 428, coupled to the pad flange 324 of the first track 304 and the second track 308.

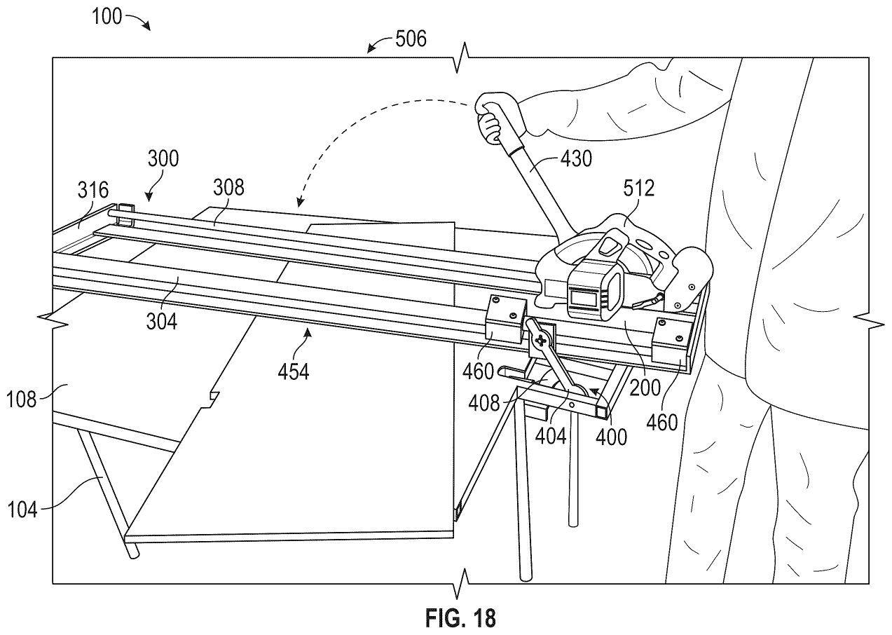

According to an embodiment, collectively, the linkage assembly 400 (e.g., the first linkage assembly 400a, the second linkage assembly 400b, the third linkage assembly 400c, and the fourth linkage assembly 400d) movably couples the guide 300 with the frame 104. The linkage assembly 400 facilitates movement of the guide 300 relative to the frame 104 between an extended position, shown in FIGS. 1-4, 7, 11, and 16 as first position 450, and a clamped position, shown in FIGS. 18-21 as second position 454. In the first position 450, the guide 300 is vertically spaced from the platform 108 to provide a space to position and orient the material on the platform 108 below the guide 300 (e.g., between the platform 108 and the first and second tracks 304, 308). In the second position 454, the guide 300 clamps the material between the guide 300 and the platform 108 to inhibit movement of the material. In the second position 454, the first pad 328 and the second pad 332 positioned along the bottom surfaces of the first track 304 and the second track 308, respectively, engage with the material. In embodiments including the first material support 120 and the second material support 124, the first material support 120 and the second material support 124 engage with a bottom surface of the material clamped by the guide 300 when the guide 300 is in the second position 454.

According to an embodiment, the first bracket 404, the second bracket 408, the gas spring 412, and the portion of the frame 104 extending between the first bracket 404 and the gas spring 412 operate as a four-bar linkage assembly (e.g., a bi-stable mechanism, an over center mechanism, a toggle lock mechanism, etc.) transitionable between two stable, equilibrium positions. The equilibrium positions may be determined by the geometry (e.g., length) of the components of the linkage assembly 400 (e.g., the first bracket 404, the second bracket 408, the gas spring 412, and the portion of the frame 104 extending between the first bracket 404 and the gas spring 412). In the first position 450, the first bracket 404 and the second bracket 408 coupled therewith are positioned such that the gas spring 412 coupled with the second bracket 408 is at least partially extended such that the gas spring 412 provides a spring force on the second bracket 408 and the first bracket 404 to bias the guide 300 to the first position 450.

To transition the guide 300 from the first position 450 to the second position 454 (e.g., after the material is at a desired position and orientation on the platform 108), an external force is applied to the handle 430 (e.g., a user pulls, pushes, or otherwise moves the handle 430) causing corresponding movement of the first bracket 404 coupled with the handle 430 and movement of the second bracket 408 coupled with the first bracket 404. The handle 430 may be moved to cause corresponding movement of the first bracket 404, the second bracket 408, and the gas spring 412 past an over-center position to transition the guide 300 from the first position 450 to the second position 454. The over-center position may be a position of the linkage assembly 400 at which the gas spring 412 is substantially parallel with the portion of the frame 104 extending between the first bracket 404 and the gas spring 412. In other words, at the over-center position, the gas spring 412 extends substantially linearly between (i) the pivot point between the first bracket 404 and the frame 104 and (ii) the pivot point between the gas spring 412 and the frame 104. According to an embodiment, moving the guide 300 from the first position 450 to the over-center position causes the gas spring 412 to compress (e.g., the external force applied to the handle 430 overcomes the spring force provided by the gas spring 412 to compress the gas spring 412). The external force may continue to be applied to the handle 430 such that the gas spring 412 moves (e.g., pivots) past the over-center position (e.g., in a direction vertically downwards, such that the gas spring 412 is at a negative angle relative to the portion of the frame 104 extending between the first bracket 404 and the gas spring 412, etc.). Once the gas spring 412 is past the over-center position, the gas spring 412 extends (e.g., the arcuate shape of the second bracket 408 facilitates extending the gas spring 412) to provide the spring force on the second bracket 408 and the first bracket 404 to bias the guide 300 to the second position 454, thereby retaining the guide 300 in the second position 454 to provide the clamping force to the material. In some embodiments, the user continues to apply the external force to the handle 430 to increase the clamping force until a sufficient (e.g., desired) clamping force is applied to the material.

To move the guide 300 from the second position 454 to the first position 450 (e.g., after cutting the clamped material, to adjust a position of the material on the platform 108, etc.), the steps described above may be performed in reverse order. By way of example, the user may apply an external force (e.g., in an opposite direction of the force applied to the handle 430 to transition the guide 300 from the first position 450 to the second position 454) to the handle 430 causing corresponding movement of the first bracket 404 and the second bracket 408 to pivot and compress the gas spring 412 to the over-center position. The external force may continue to be applied to the handle 430 such that the gas spring 412 moves (e.g., pivots) past the over-center position (e.g., in a direction vertically upwards, such that the gas spring 412 is at a positive angle relative to the portion of the frame 104 extending between the first bracket 404 and the gas spring 412, etc.). Once the gas spring 412 is past the over-center position, the gas spring 412 extends (e.g., the arcuate shape of the second bracket 408 facilitates extending the gas spring 412) to provide the spring force on the second bracket 408 and the first bracket 404 to bias the guide 300 to the first position 450, thereby retaining the guide 300 in the first position 450.

As shown in FIGS. 1-8, 10, and 11, (i) the first cross-member 312 is coupled to the first track 304 and the second track 308, (ii) the second cross-member 316 is coupled to the first track 304 and the second track 308, and (iii) the linkage assembly 400 movably couples the first track 304 and the second track 308 with the frame 104 such that movement of one of the first track 304 or the second track 308 (e.g., movement of the guide 300) between the first position 450 and the second position 454 caused by moving the handle 430 causes corresponding movement of the other one of the first track 304 or the second track 308.

As shown in FIGS. 1-3, 7-11, and 16-21, the cutting assembly 100 includes a plurality of rolling elements (e.g., linear bearings), shown as bearings 460, configured to couple to the first brackets 240 and the second bracket 244 of the tray 200. The bearings 460 are coupled with the guide 300 to facilitate translational movement of the tray 200 (and the saw coupled therewith) along the guide 300. Specifically, the bearings 460 may be received around the bearing engagement portion 320 of the first track 304 and the second track 308 such that the tray 200 is slidably coupled with the first track 304 and the second track 308. Accordingly, the bearings 460 facilitate translational movement of the tray 200 along the length of the first track 304 and the second track 308. According to an embodiment, when the guide 300 is in the second position 454 and the material is clamped by the guide 300, the tray 200 moves along the length of the guide 300 such that the blade of the saw coupled to the tray 200 cuts the material clamped between the guide 300 and the platform 108.

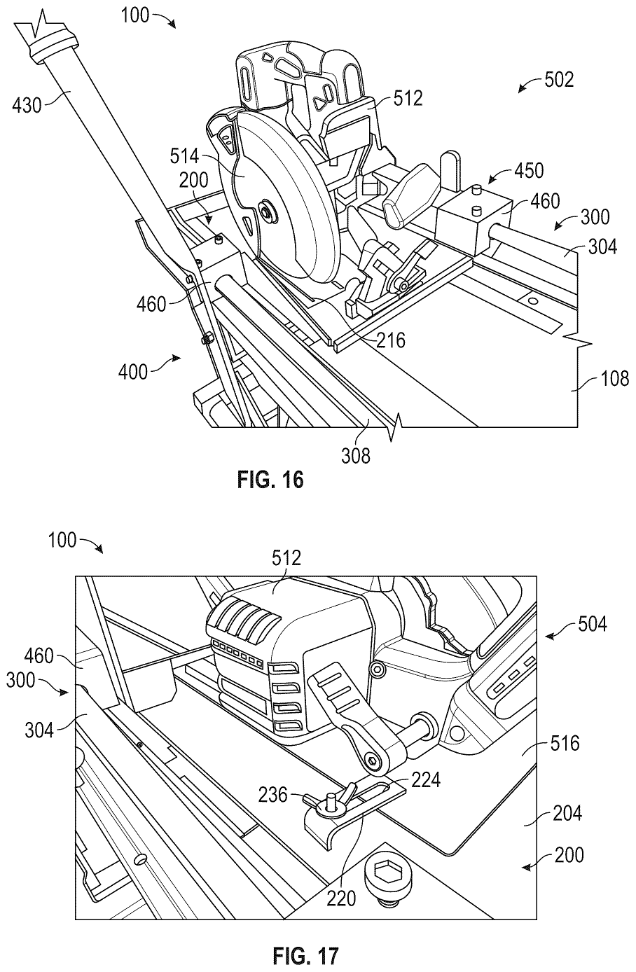

As shown in FIGS. 16-21, a method of clamping and cutting a material using the cutting assembly 100 is shown including steps 502-510. At step 502, a saw (e.g., circular saw, jigsaw, etc.), shown as saw 512, is supported on the tray 200. The saw 512 may be positioned on the tray 200 such that a blade, shown as saw blade 514, of the saw 512 is aligned with (e.g., received by) the blade slot 216. At step 504, the saw clamps 220 engage with a plate (e.g., shoe), shown as base plate 516, of the saw 512 to secure the saw 512 to the tray 200 and inhibit movement of the saw 512 along the tray 200 during cutting operations. The nuts 236 may be turned to increase the force on the tray 200 and the saw clamps 220 (e.g., to increase the clamping force on the saw 512) such that the saw is secured to the tray 200 by the saw clamps 220.

At step 506, the material is supported by the platform 108 at a desired position and orientation relative to the cutting path of the saw 512 (e.g., to cut the material at a desired angle, position, etc.). The material may engage with the first pin 136 and the second pin 140 to orient the material at the angle established based on the positions of the first pin 136 and the second pin 140. Further, the material may be positioned to align a desired cutting path along the material with the second pad 332 providing an indication of the path of the saw blade 514 as the tray 200 moves along the length of the guide 300. After positioning the material, at step 506, the user provides an external force to the handle 430 to move the handle 430 (e.g., in the direction indicated by the dashed arrow shown in FIG. 18) and transition the guide 300 from the first position 450 to the second position 454. In the second position 454, the guide 300 engages with the material to clamp the material between the guide 300 and the platform 108, thereby inhibiting movement of the material. In some embodiments, step 506 (e.g., positioning the material and transitioning the guide 300 to the second position 454) occurs prior to steps 502 and 504 (e.g., securing the saw 512 to the tray 200).

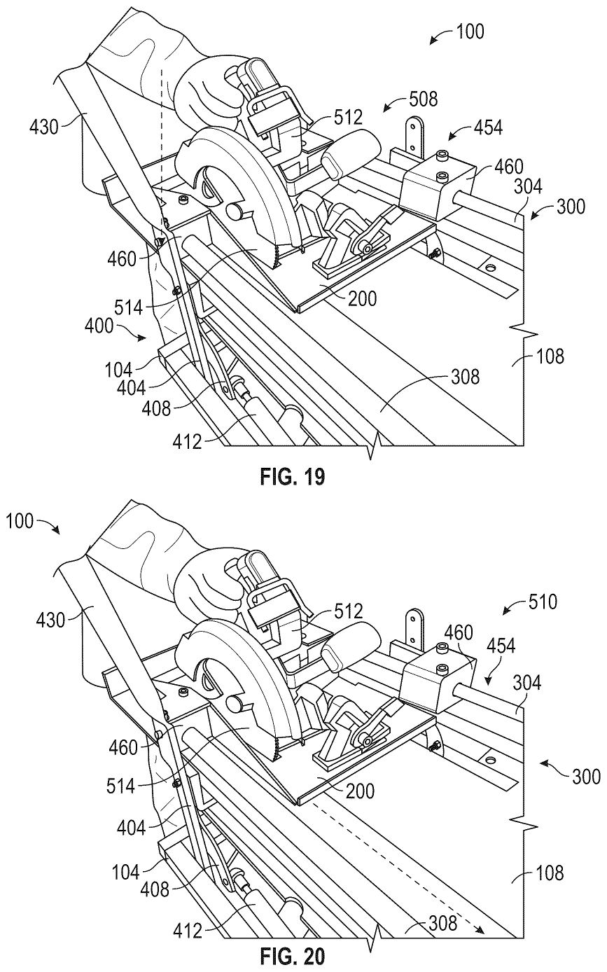

At step 508, the saw 512 is plunged downwards (e.g., in the direction indicated by the dashed arrow shown in FIG. 19) such that the saw blade 514 extends below the base plate 516 and is received within the blade slot 216. In some embodiments, the saw 512 is configured such that the saw blade 514 is always positioned, at least partially, below the base plate 516 (e.g., the saw 512 does not need to be plunged downwards to position the saw blade 514 within the blade slot 216). In such embodiments, step 508 may be omitted.

At step 510 shown in FIGS. 20 and 21, the user engages with the saw 512 (e.g., grabs the saw 512 at the handles thereof) and pushes the saw 512 to translate the tray 200 and the saw 512 coupled therewith along the length of the guide 300 (e.g., in the direction indicated by the dashed arrow shown in FIGS. 20 and 21). As the tray 200 and the saw 512 move along the guide 300, the saw blade 514 extends through the blade slot 216 and cuts the material. The tray 200 and the saw 512 may be moved along the guide 300 to partially cut the material or entirely cut the material (e.g., into two or more pieces). After cutting the material, the guide 300 may be moved back to the first position 450 and the material may be removed from the cutting assembly 100. This process may be repeated to cut multiple pieces of material.

In some embodiments, when the guide 300 is in the first position 450 and the saw 512 is secured to the tray 200, the tray 200 may be positioned sufficiently high enough above the material supported on the platform 108 such that the saw blade 514 does not contact the material if the tray 200 and the saw blade 514 secured thereto are moved along the guide 300. In such an embodiment, the cutting assembly 100 may prevent the material from being cut when the guide 300 is not in the second position 454 clamping the material.

As shown in FIG. 22, the material is configured as a tile (e.g., sheet metal), shown as roofing tile 520. The end portions of the roofing tile 520 define irregular geometries to facilitate coupling the roofing tile 520 to a roof (e.g., installing the roofing tile 520) and a top portion extending between the end portions. The top portion is substantially flat and the end portions extend, generally, downwards from the top portion such that, when the roofing tile 520 is supported on a surface (e.g., the platform 108, a ground surface, etc.), the end portions contact the surface, and the top portion is spaced from surface. In some embodiments, the roofing tile 520 is supported by the platform 108 and clamped by the guide 300 to be cut by the saw. In such embodiments example, one or both of the end portions may contact the platform 108. To stabilize and support the roofing tile 520 before, during, and after cutting the roofing tile 520, the first material support 120 and the second material support 124 may engage with a bottom surface of the roofing tile 520. In some embodiments, the roofing tile 520 is otherwise shaped. In some embodiments, the cutting assembly 100 is configured to facilitate clamping and cutting materials other than the roofing tile 520.

As shown in FIG. 22, the end portions of the roofing tile 520 overlaps with itself to form a complex and irregular geometry. In some embodiments, the roofing tile 520 is positioned along the platform 108 and clamped by the guide 300 such that the saw 512 cuts the end portions with the complex and irregular geometry. In other cutting assemblies or cutting mechanisms, cutting materials with complex and irregular geometries may be difficult of impossible because of the complex bend lines, and may cause the material to deform during cutting operations. Further, other cutting assemblies may be unable to cut through multiple layers of material (e.g., end portions of the roofing tile 520 overlapping with itself).

The cutting assembly 100 may provide additional advantages over other cutting assemblies or cutting mechanisms. The frame 104, the platform 108, and the guide 300 of the cutting assembly 100 may be sufficiently long enough to cut roofing tiles that other cutting assemblies or cutting mechanisms may be unable to cut. Further, the cutting assembly 100 facilitates clamping the material prior to cutting operations such that the operator can grab the handles of the saw with both hands. Other cutting assemblies or cutting mechanisms may require the user to hold or otherwise secure the material with one hand and grab the saw with the other hand, which may be dangerous to the operator or may cause unprecise cutting of the material. Further, the cutting assembly 100 may facilitate the use of saws of different types, from different manufacturers, etc. Other cutting assemblies or cutting mechanisms may require a specific type of saw. Further, the saw is detachable from the cutting assembly 100, making the cutting assembly 100 lighter and easy to transport (e.g., between jobsites, to different locations at a jobsite, etc.). Other cutting assemblies or cutting mechanisms may include a saw integrally formed therewith, making them heavy and difficult to transport. In some embodiments, the other cutting assemblies or cutting mechanisms may be required to be fixed to a ground surface, and thus may not be able to be transported.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the cutting assembly 100 as shown in the various exemplary embodiments is illustrative only. Additionally, any element disclosed in one embodiment may be incorporated or utilized with any other embodiment disclosed herein.

What is claimed is:

1. A cutting assembly comprising:
a frame;
a support surface supported by the frame and configured to support a material;
a guide coupled with the frame; and
a tray coupled with the guide and configured to support a saw, the tray defining an opening positioned to receive a blade of the saw,
wherein the guide is configured to move relative to the support surface between a first position and a second position,
wherein, in the second position, the guide clamps the material between the guide and the support surface, and
wherein the tray is configured to move along a length of the guide such that the blade of the saw cuts the material clamped between the guide and the support surface.

2. The cutting assembly of claim 1, further comprising a linkage assembly movably coupling the guide with the frame, wherein the linkage assembly includes a biasing element configured to bias the guide into the first position or the second position.

3. The cutting assembly of claim 2, wherein the biasing element is pivotably coupled with the frame at a first end thereof, and wherein the linkage assembly includes:
a first bracket pivotably coupled with the guide and the frame; and
a second bracket pivotably coupled with the biasing element at a second end thereof and coupled with the first bracket between the guide and the frame.

4. The cutting assembly of claim 3, wherein the linkage assembly includes a handle coupled with the first bracket to facilitate moving the guide between the first position and the second position.

5. The cutting assembly of claim 2, wherein the biasing element is a gas spring.

6. The cutting assembly of claim 1, wherein the guide includes a first track and a second track laterally spaced apart from each other, and wherein the tray is slidably coupled with the first track and the second track.

7. The cutting assembly of claim 6, further comprising:
a first linkage assembly and a second linkage assembly movably coupling the first track of the guide with the frame; and
a third linkage assembly and a fourth linkage assembly movably coupling the second track of the guide with the frame.

8. The cutting assembly of claim 7, further comprising a cross-member coupling the first track with the second track such that movement of one of the first track or the second track causes corresponding movement of the other one of the first track or the second track.

9. The cutting assembly of claim 1, further comprising a pad positioned along a bottom surface of the guide to engage with the material when the guide is in the second position.

10. The cutting assembly of claim 9, wherein the pad provides an indication of a path that the blade of the saw follows as the tray moves along the length of the guide.

11. The cutting assembly of claim 1, wherein the tray includes at least one clamp configured to secure the saw to the tray.

12. The cutting assembly of claim 1, wherein the tray includes a bearing coupled with the guide to facilitate translational movement of the tray along the guide.

13. The cutting assembly of claim 1, wherein the support surface defines a first slot extending in a longitudinal direction and a second slot extending in the longitudinal direction and laterally spaced from the first slot, the cutting assembly further comprising a first pin configured to be received within the first slot, and a second pin configured to be received within the second slot, wherein the first pin and the second pin are configured to engage with the material to orient the material at an angle relative to the guide, and wherein the first pin is selectively repositionable along the first slot and the second pin is selectively repositionable along the second slot to adjust the angle at which the material is oriented.

14. The cutting assembly of claim 1, wherein the support surface defines an opening positioned to receive the blade of the saw.

15. A cutting assembly comprising:
a frame;
a support surface supported by the frame and configured to support a material;
a guide coupled with the frame, the guide including:
a first track extending in a longitudinal direction;
a second track extending in the longitudinal direction, the second track laterally spaced from the first track; and
a cross-member extending in a lateral direction between the first track and the second track; and
a tray slidably coupled with the first track and the second track, the tray including a clamp configured to secure a saw to the tray, the tray defining an opening positioned to receive a blade of the saw,
wherein the guide is configured to move relative to the support surface between a first position and a second position,
wherein, in the second position, the guide clamps the material between the guide and the support surface, and
wherein the tray is configured to translate along a length of the guide such that the blade of the saw cuts the material clamped between the guide and the support surface.

16. The cutting assembly of claim 15, further comprising a first pad positioned along a bottom surface of the first track and a second pad positioned along a bottom surface of the second track, wherein the first pad and the second pad engage with the material when the guide is in the second position.

17. The cutting assembly of claim 16, wherein the first pad or the second pad provides an indication of a path that the blade of the saw follows as the tray translates along the length of the guide.

18. A cutting assembly comprising:
a frame;
a support surface supported by the frame and configured to support a material;
a guide coupled with the frame;
a tray coupled with the guide and configured to support a saw, the tray defining an opening positioned to receive a blade of the saw; and
a first linkage assembly, a second linkage assembly, a third linkage assembly, and a fourth linkage assembly each movably coupling the guide with the frame such that the guide is repositionable between a first position and a second position,
wherein the first linkage assembly and the second linkage assembly each include:
a gas spring pivotably coupled with the frame at a first end thereof;
a first bracket pivotably coupled with the guide and the frame; and
a second bracket pivotably coupled with the gas spring at a second end thereof and coupled with the first bracket between the guide and the frame,
wherein the third linkage assembly and the fourth linkage assembly each include a third bracket pivotably coupled with the guide and the frame,
wherein, in the second position, the guide clamps the material between the guide and the support surface, and
wherein the tray is configured to move along a length of the guide such that the blade of the saw cuts the material clamped between the guide and the support surface.

19. The cutting assembly of claim 18, further comprising a handle coupled with the first bracket of the first linkage assembly or the second linkage assembly to facilitate moving the guide between the first position and the second position.

20. The cutting assembly of claim 18, wherein the guide includes:
a first track extending in a longitudinal direction along the length of the guide; and
a second track extending in the longitudinal direction along the length of the guide, the second track laterally spaced from the first track,
wherein the first linkage assembly and the second linkage assembly are coupled to the first track and the second track, respectively, proximate a first longitudinal end of the guide, and
wherein the third linkage assembly and the fourth linkage assembly are coupled to the first track and the second track, respectively, proximate a second longitudinal end of the guide.
